(19) United States
(12) Patent Application Publication
(10) Pub. No.: US 2026/0120118 A1
(43) Pub. Date: Apr. 30, 2026

(54) DIGITAL CALIBRATION CERTIFICATE (DCC) GENERATION AND VERIFICATION METHOD AND SYSTEM BASED ON MICROSERVICES ARCHITECTURE

(71) Applicant: NATIONAL INSTITUTE OF METROLOGY OF CHINA, Beijing (CN)

(72) Inventors: Xingchuang XIONG, Beijing (CN); Xiang FANG, Beijing (CN); Wenkui HE, Beijing (CN); Zhen LIU, Beijing (CN); Zilong LIU, Beijing (CN); Kan KAN, Beijing (CN)

(73) Assignee: NATIONAL INSTITUTE OF METROLOGY OF CHINA, Beijing (CN)

(21) Appl. No.: 19/149,851

(22) PCT Filed: May 17, 2024
(86) PCT No.: PCT/CN2024/093791

§ 371 Date: Jul. 22, 2025

(30) Foreign Application Priority Data
Apr. 25, 2024 (CN) 202410507432.5

(51) Int. Cl. H04L 9/40

(52) U.S. Cl. CPC H04L 63/0823; H04L 63/123

(57) ABSTRACT

A digital calibration certificate (DCC) generation and verification method and system based on microservices architecture includes: a user subsystem configured to acquire DCC content information and transmit a DCC generation and verification result to a user; a service subsystem configured to provide an access service and acquire calibration business data based on the DCC content information; a processing subsystem configured to generate a DCC based on the DCC content information and the calibration business data and verify the DCC, and obtain the DCC generation and verification result; a digital security subsystem configured to authenticate the user subsystem through the service subsystem and provide a digital signature and a trusted timestamp to the processing subsystem; and a storage subsystem configured to store information and data during processing and provide corresponding information and data to the processing subsystem.

### CROSS REFERENCE TO THE RELATED APPLICATIONS

This application is the national phase entry of International Application No. PCT/CN2024/093791, filed on May 17, 2024, which is based upon and claims priority to Chinese Patent Application No. 202410507432.5, filed on Apr. 25, 2024, the entire contents of which are incorporated herein by reference.

### TECHNICAL FIELD

The present disclosure relates to the technical field of security protection, and in particular to a digital calibration certificate (DCC) generation and verification method and system based on microservices architecture.

### BACKGROUND

Modern metrology must address the challenges of the digital era, and metrology is entering the digital era. The International System of Units (SI) digital framework and the findable, accessible, interoperable, and reusable (FAIR) principles for metrological data mark the global metrology field's high regard and consensus on the digital transformation of metrology. Calibration certificates are crucial information carriers for measurement traceability. Digital calibration certificates (DCCs), as vital information carriers for measurement traceability in the digital world, are in a unified and standardized format that is machine-readable and machine-operable.

The Physikalisch-Technische Bundesanstalt (PTB) has conducted extensive pioneering work in DCC metamodel development and best practice development, etc. It has chaired four International DCC conferences, making significant contributions to the global promotion and popularization of DCCs. The PTB developed the GEMIMEG-Tool, a web-based tool for DCC generation and verification, but it still has a considerable distance to cover before being suitable for practical large-scale production applications. Based on the PTB-DCC metamodel, the National Institute of Metrology, China (NIM) developed a bilingual (Chinese/English) NIM-DCC metamodel, alongside standalone NIM-DCC generation software and verification software. However, they all fail to simultaneously meet the information requirements of the metrology industry, information requirements of the information technology (IT) industry, digital security requirements, and the FAIR principles for metrological data.

### SUMMARY

To address the above deficiencies in the prior art, the present disclosure provides a digital calibration certificate (DCC) generation and verification method and system based on microservices architecture, solving the problem that DCCs fail to meet standard requirements.

To achieve the above objective, the present disclosure adopts the following technical solutions. A DCC generation and verification system based on microservices architecture includes:
a user subsystem, configured to acquire DCC content information and transmit a DCC generation and verification result to a user;
a service subsystem, configured to provide an access service and acquire calibration business data based on the DCC content information;
a processing subsystem, configured to generate a DCC based on the DCC content information, the calibration business data, a digital signature, and a trusted timestamp, verify the DCC, and obtain the DCC generation and verification result;
a digital security subsystem, configured to authenticate the user subsystem through the service subsystem and provide the digital signature and the trusted timestamp to the processing subsystem; and
a storage subsystem, configured to store information and data during processing and provide corresponding information and data to the processing subsystem.

The present disclosure has the following beneficial effects. The DCC generation and verification system based on microservices architecture utilizes the user subsystem, the service subsystem, the processing subsystem, the digital security subsystem, and the storage subsystem to generate and verify the DCC, and obtain the DCC generation and verification result. (1) The present disclosure achieves high reliability, high stability, and easy iteration for the system through the microservices architecture. (2) The present disclosure standardizes, regulates, and streamlines information of calibrators, reviewers, and approvers using the DCC template and verification process. (3) The present disclosure ensures that the generated DCC meets IT requirements through the format verification process. (4) The present disclosure provides digital certificates to the calibration institutions, calibrators, reviewers, and approvers, utilizes the digital certificates to digitally sign the DCC, and applies trusted timestamps to the DCC content. Thus, the present disclosure ensures data integrity without tampering, and guarantees credible provider identity and data authenticity of the DCC. (5) The present disclosure incorporates the certificate management unit, ensuring that the compliantly produced DCC possesses a unique DOI for findability and accessibility of the DCC. The present disclosure verifies machine-readable and operable syntax compliance of the DCC to achieve operability and reusability, satisfying FAIR principles.

Furthermore, the user subsystem includes:
a terminal module, configured to acquire the DCC content information through a terminal device; and
a server module, configured to transmit the DCC content information to the service subsystem.

Furthermore, the service subsystem includes:
a network service module, configured to provide the user with an access service to the generation and verification system; and
a digital calibration service module, configured to acquire the calibration business data based on the DCC content information through a time-frequency calibration business service and a length calibration business service.

Furthermore, the processing subsystem includes:
an interface module, configured to establish a security mechanism and connect the service subsystem to a business module and a core management module;
the business module, configured to generate the DCC based on the DCC content information, the calibration business data, the digital signature, and the trusted timestamp;
the core management module, configured to verify the DCC, and obtain the DCC generation and verification result; and
a configuration module, configured to configure and manage the business module and the core module.

Furthermore, the business module includes:
a module management unit, configured to acquire a corresponding DCC template based on a metrological standard in a specialized field;
a generation unit, configured to generate the DCC based on the DCC template, the DCC content information, and the calibration business data;
a security management unit, configured to apply the digital signature and a timestamp endorsement to the DCC, and obtain a security-managed DCC; and
a verification unit, configured to perform format, syntax, and security verification on the security-managed DCC, to obtain a final DCC.

Furthermore, the core management module includes:
a certificate management unit, configured to perform version update, query, and publication of the DCC and a corresponding digital unit system based on the DCC;
a permission management unit, configured to provide registration, permission assignment, and authentication management services for the user in the system;
a verification and calculation unit, configured to provide a corresponding calibration calculation function and verify the DCC through a verification and calculation tool based on a metrological standard, professional terminology, and a verification code, and obtain the DCC generation and verification result;
an identifier management unit, configured to generate a persistent identifier (PID) and a digital object identifier (DOI) based on the verified DCC, thereby implementing registration of the DCC; and
a vocabulary management unit, configured to provide the metrological standard, the professional terminology, and the verification code, thereby implementing a DCC generation and verification process.

Furthermore, the configuration module includes:
a configuration unit, configured to provide an information configuration service for the business module and the core management module;
a log management unit, configured to manage logs generated in the business module and the core management module;
a registration-discovery unit, configured to provide a registration-discovery component for the business module and the core management module and perform dynamic scheduling of the module based on a current application scale; and
a microservices unit, configured to visualize the business module and the core management module and manage the generated DCC.

Furthermore, the digital security subsystem includes:
a digital identity module, configured to provide digital identity information for the terminal module and the server module;
a digital signature module, configured to generate the digital signature through a cryptographic device; and
a trusted timestamp module, configured to generate the trusted timestamp through a timestamp server.

Furthermore, the storage subsystem includes:
a user information storage module, configured to store user information, authentication information, and management information;
a certificate information storage module, configured to store a DCC file, the signature, the timestamp, process data, and management data;
a key information storage module, configured to store the digital signature and a corresponding key; and
a data information storage module, configured to store the business data, background service data, and process control data.

A DCC generation and verification method based on microservices architecture includes: acquiring the DCC content information;
acquiring the calibration business data based on the DCC content information;
generating the digital signature and the trusted timestamp; and
generating the DCC based on the DCC content information, the calibration business data, the digital signature, and the trusted timestamp, verifying the DCC, and obtaining the DCC generation and verification result.

### BRIEF DESCRIPTION OF THE DRAWINGS

This specification will be further illustrated through exemplary embodiments, which will be described in detail with reference to the drawings. These embodiments are not restrictive, and the same reference numerals herein refer to the same structures.

FIG. 1 is a block diagram of a digital calibration certificate (DCC) generation and verification system based on microservices architecture according to some embodiments of this specification, for an application scenario; and

FIG. 2 shows an exemplary flowchart of a DCC generation and verification method based on microservices architecture according to some embodiments of the present disclosure.

### DETAILED DESCRIPTION OF THE EMBODIMENTS

The specific embodiment of the present disclosure will be described below so that those skilled in the art can understand the present disclosure, but it should be clear that the present disclosure is not limited to the scope of the specific embodiment. For those of ordinary skill in the art, as long as various changes fall within the spirit and scope of the present disclosure defined and determined by the appended claims, these changes are apparent, and all inventions and creations using the concept of the present disclosure are protected.

### Embodiment 1

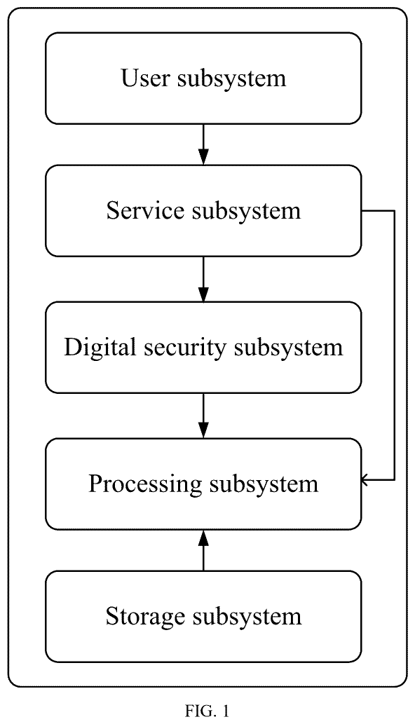

FIG. 1 is a block diagram of a digital calibration certificate (DCC) generation and verification system based on microservices architecture according to some embodiments of this specification.

In some embodiments, the DCC generation and verification system based on microservices architecture may include a user subsystem, a service subsystem, a processing subsystem, a digital security subsystem, and a storage subsystem.

The user subsystem is configured to acquire DCC content information and transmit a DCC generation and verification result to a user.

The DCC content information is calibration process description information. For example, the DCC content information may include calibration object, calibration time, administrative data, calibration institution, calibration environment, calibration method, calibration instrument, and calibration result data, etc.

In some embodiments, the user subsystem may include a terminal module and a server module.

The terminal module is configured to acquire the DCC content information through a terminal device.

The terminal device may include a computer, a tablet computer, a calibration instrument, etc.

In some embodiments, the terminal module may upload raw data of a calibration certificate through the terminal device and acquire the DCC content information.

The server module is configured to transmit raw data of the calibration certificate from the user subsystem to the service subsystem and transmit the DCC content information to the terminal module.

In some embodiments, an authorized user subsystem may transmit the DCC content information from the service subsystem to the user subsystem via the internet. For example, the server may authorize the user subsystem using a universal serial bus (USB) smart security key.

The DCC generation and verification result reflects whether the DCC generation format and calibration result comply with standards. For example, the DCC generation and verification result may include a DCC generation format, whether the calibration result complies with a standard, a specific generation time of the certificate, and digital signature information in the certificate (calibrator, reviewer, approver, institution, etc.).

The service subsystem is configured to provide an access service and acquire calibration business data based on the DCC content information.

In some embodiments, the service subsystem may provide the user with a visual access service.

The calibration business data relates to a specific calibration business processing procedure. For example, the calibration business data may include time-frequency calibration business data and length calibration business data.

In some embodiments, the service subsystem may include a network service module and a digital calibration service module.

The network service module is configured to provide the user with an access service to the generation and verification system.

In some embodiments, the network service module may provide the user with a visual access through a Web page deployed on a front-end web server, assisting the user in selecting a DCC generation and calibration service.

The digital calibration service module is configured to acquire the calibration business data based on the DCC content information through a time-frequency calibration business service and a length calibration business service.

The time-frequency calibration business service is a service for calibrating time and frequency. A time difference and an uncertainty between a calibrated global navigation satellite system (GNSS) receiver and a reference GNSS receiver are calculated through data from the calibrated GNSS receiver and the reference GNSS receiver. A DCC is generated through the processing subsystem and fed back to the calibrated receiver. The calibrated receiver completes certificate verification based on the received DCC. The calibration result in the DCC is parsed to complete receiver calibration.

The length calibration business service is a service for generating the DCC based on the length calibration result data. A calibration laboratory measures a target object under a specified experimental condition according to a metrological calibration specification, acquires raw measurement data, and calculates an average deviation and uncertainty. This service generates the corresponding DCC based on the calibration specification, the calibration environment, the calibration result, and other related information, and feeds the DCC back to the end user.

In some embodiments, the digital calibration service module may acquire corresponding business data from the digital security subsystem and the storage subsystem based on the time-frequency calibration business service and the length calibration business service.

The processing subsystem is configured to generate the DCC based on the DCC content information, the calibration business data, a digital signature, and a trusted timestamp, verify the DCC, and obtain the DCC generation and verification result.

The DCC utilizes the calibration content to certify measurement equipment's accuracy and traceability.

In some embodiments, the processing subsystem may generate the corresponding DCC based on the DCC content information and the calibration business data.

In some embodiments, the processing subsystem may include an interface module, a business module, a core management module, and a configuration module.

The interface module is configured to establish a security mechanism and connect the service subsystem to the business module and the core management module.

The security mechanism is configured to control a secure address interaction. For example, the security mechanism may include address whitelist settings, address blacklist settings, rate limiting, and circuit breaking.

In some embodiments, the interface module may connect the service subsystem to the business module and the core management module through the security mechanism and transmit the DCC content information and the calibration business data to the business module and the core management module.

The business module is configured to generate the DCC based on the DCC content information, the calibration business data, the digital signature, and the trusted timestamp.

In some embodiments, the business module may include a module management unit, a generation unit, a security management unit, and a verification unit.

The module management unit is configured to acquire a corresponding DCC template based on a metrological standard in a specialized field.

The metrological standard, having lower accuracy than the metrological benchmark, verifies other metrological standards or working measuring instruments, with different specialized fields having corresponding metrological standards.

In some embodiments, the module management unit may determine a corresponding metrological standard by retrieval in a specialized field of the DCC.

The DCC template is a template for acquiring the DCC content information. For example, the DCC template may include a calibration object section, a calibration institution section, a calibration environment section, a calibration process section, and a calibration result section.

In some embodiments, the user subsystem may acquire the corresponding DCC content information through the terminal device by dividing the DCC template into the calibration object section, the calibration institution section, the calibration environment section, the calibration process section, and the calibration results section. For example, the calibration object section may acquire company name, address, and calibration time of the calibrated object. The calibration institution section may acquire name and responsible person information of the calibration institution. The calibration environment section may acquire the calibration environmental condition and location. The calibration process section may acquire the measurement method and instrument used for calibration. The calibration result section may acquire calibration result data.

The generation unit is configured to generate the DCC based on the DCC template, the DCC content information, and the calibration business data.

In some embodiments, the generation unit may assemble the DCC content information according to the DCC template, so as to acquire the DCC.

The security management unit is configured to apply the digital signature and a timestamp endorsement to the DCC, and obtain a security-managed DCC.

In some embodiments, the security management unit may acquire the corresponding digital signature and valid timestamp from the digital security subsystem based on the DCC and apply the digital signature and the timestamp endorsement to the DCC.

In some embodiments, the security management unit may generate a persistent identifier (PID) and a category identifier for the DCC according to a digital object identifier (DOI) naming standard and bind the PID to the DCC content.

In some embodiments, the security management unit may apply procedural certificate authority (CA) endorsements (e.g., calibrator, reviewer, approver, and institution) and corresponding timestamp endorsements to the DCC and encapsulate relevant CA signatures and timestamp endorsement data blocks/files, thereby acquiring a security-managed DCC.

The verification unit is configured to perform format, syntax, and security verification on the security-managed DCC, to obtain a final DCC.

In some embodiments, the verification unit may verify the file format, syntax/semantic, digital signature, and timestamp of the DCC based on the calibration business data, to obtain a final DCC.

The core management module is configured to verify the DCC, and obtain the DCC generation and verification result.

In some embodiments, the core management module may include a certificate management module, a permission management module, a verification and calculation module, an identification management module, and a vocabulary management module.

The certificate management unit is configured to perform version update, query, and publication of the DCC and a digital unit system based on the DCC.

In some embodiments, the certificate management unit may query and publish a new version through a generated extensible markup language (XML) schema definition (XSD) file based on the DCC.

The permission management unit is configured to provide registration, permission assignment, and authentication management services for the user in the system.

In some embodiments, the permission management unit may manage the user permission, provide corresponding registration services and role assignments for different user types (e.g., certificate provider, verification user), assign permissions based on different user types, and perform authentication management.

The verification and calculation unit is configured to provide a corresponding calibration calculation function and verify the DCC through a verification and calculation tool based on a metrological standard, professional terminology, and a verification code, and obtain the DCC generation and verification result.

The verification and calculation tool may is a method and tool for calibrating and verifying the DCC.

In some embodiments, the verification and calculation unit may verify the DCC using a targeted verification and calculation tool based on the specialized field and corresponding metrological standard of the DCC, thereby acquiring the DCC generation and verification result.

In some embodiments, the verification and calculation unit may calculate a hash value of the DCC file using a hash algorithm declared in the timestamp endorsement data based on the DCC and the corresponding timestamp endorsement data, compare the hash value with a hash value of the DCC stored in the timestamp endorsement data, determine hash validity through consistency, and verify a hash signature value of the DCC in the timestamp endorsement data using a timestamp certificate public key in the timestamp endorsement data.

In some embodiments, the verification and calculation unit may verify the legitimacy of corresponding signature information using the DCC file and the corresponding signature result data according to the CA certificate number in the signature data (matching the CA certificate) or the certificate entity, for example, the signature legitimacy of the calibrator, verifier, approver, and institution.

In some embodiments, the verification and calculation unit may read the corresponding version through the DCC file and perform syntax/semantic verification on the DCC file using an XSD file defining a metamodel for the corresponding version. For example, the verification and calculation unit may verify the completeness of elements and nodes included in the DCC, the legitimacy of element names and data types, the completeness/legitimacy of each data node description, the legitimacy of values, and the legitimacy of unit systems based on professional terminology and verification codes, etc.

The identifier management unit is configured to generate the PID and a DOI based on the verified DCC, thereby implementing registration of the DCC.

The PID is an identifier generated by the system during DCC verification.

The DOI is a network identifier generated after DCC verification.

In some embodiments, the identifier management unit may acquire the corresponding PID and DOI based on the DCC verification process and register the DOI.

The vocabulary management unit is configured to provide the metrological standard, the professional terminology, and the verification code, thereby implementing a DCC generation and verification process.

Professional terminology may include terms from specialized fields corresponding to calibration methods. For example, professional terminology may include metrological terms defined in International Vocabulary of Metrology (VIM) such as units, quantities, values, measurement principles, measurement methods, measuring instruments, measuring devices, and uncertainties.

The verification code is data for verifying the DCC.

In some embodiments, the vocabulary management unit may provide referenced metrological standards, professional terminology, and verification data for the DCC generation and verification.

The configuration module is configured to configure and manage the business module and the core module.

In some embodiments, the configuration module may include a configuration unit, a log management unit, a registration-discovery unit, and a microservices unit.

Microservices are various services in the system accessible and selectable by the user. For example, microservices may include query services, DCC generation services, and verification services.

The configuration unit is configured to provide an information configuration service for the business module and the core management module.

In some embodiments, the configuration unit may serve as a configuration service center in microservices management, providing unified configurations for all microservices. For example, the configuration unit may configure service ports, database connection uniform resource locators (URLs), and log levels.

The log management unit is configured to manage logs generated in the business module and the core management module.

In some embodiments, the log management unit may provide a centralized log management function for all microservices. For example, the log management unit may perform log collection, log storage, log retrieval, and log querying for all microservices.

The registration-discovery unit is configured to provide a registration-discovery component for the business module and the core management module and perform dynamic scheduling of the module based on a current application scale.

The registration-discovery component reflects a relationship between a microservices quantity and the user.

In some embodiments, the registration-discovery unit may utilize the registration-discovery component to provide dynamic scheduling capabilities for internal microservices, dynamically increasing or decreasing service quantities based on current application scale, and providing load balancing support.

The microservices unit is configured to visualize the business module and the core management module and manage the generated DCC.

In some embodiments, the microservices unit may transmit a microservices project to the service subsystem for a visual access by the user.

In some embodiments, the microservices unit may manage the generated DCC using storage and scheduling methods, etc.

The digital security subsystem is configured to authenticate the user subsystem through the service subsystem and provide the digital signature and the trusted timestamp to the processing subsystem.

The digital signature proves information authenticity.

The trusted timestamp represents publicly credible data reflecting content time.

In some embodiments, the digital security subsystem may include a digital identity module, a digital signature module, and a trusted timestamp module.

The digital identity module is configured to provide digital identity information for the terminal module and the server module.

In some embodiments, the digital identity module may provide digital identity services (e.g., CA certificate services) for various terminals, distribute certificates through commercial cryptographic devices (e.g., USBKey, TransFlash (TF) cryptographic cards), and provide digital identities for terminals.

The digital signature module is configured to generate the digital signature through a cryptographic device.

The cryptographic device is configured to provide signing services and can generate random numbers meeting the Random Number Test Specification.

In some embodiments, the cryptographic device may incorporate Rivest-Shamir-Adleman (RSA) and SM2 signature algorithms to securely store keys and prevent key readings through physical mechanisms.

In some embodiments, the digital signature module may utilize a secure hardware cryptographic card of the cryptographic device for signing and generate a digital signature through commercial cryptographic device certification.

The trusted timestamp module is configured to generate the trusted timestamp through a timestamp server.

The timestamp server can provide trusted timestamp signatures. For example, the timestamp server may include a timestamp authority (TSA) hardware product developed based on public key infrastructure (PKI) technology. It employs precise time sources, high-strength/high-standard security mechanisms, and provides the user with precise and non-repudiable timestamp services. Service interfaces request timestamps strictly compliant with the international standard RFC3161 timestamp protocol through a hypertext transfer protocol (HTTP), adopting standard RFC3161 timestamp requests, timestamp responses, and timestamp encoding formats.

In some embodiments, the trusted timestamp module may utilize the timestamp server to generate trusted timestamps through commercial cryptographic device certification and metrology-grade time sources with valid trusted calibration certificates.

The storage subsystem is configured to store information and data during processing and provide corresponding information and data to the processing subsystem.

The information and data during processing refer to data required for DCC generation and verification. For example, the information and data during processing may include user data, certificate data, key data, and business data.

In some embodiments, the storage subsystem may provide information and data during processing for the processing subsystem.

In some embodiments, the storage subsystem may include a user information storage module, a certificate information storage module, a key information storage module, and a data information storage module.

The user information storage module is configured to store user information, authentication information, and management information.

The user information refers to information required for user registration. For example, the user information may include a user address and name.

The authentication information relates to user authentication. For example, the authentication information may include a permission list owned by the user, a user login password, a user login public key, and application programming interface (API) session information.

The management information relates to user management. For example, the management information may include interrelationships between the user and the calibration institution, as well as between calibration groups, personnel roles, and approval workflows.

In some embodiments, the user information storage module may acquire and store user information, authentication information, and management information through the user subsystem.

The certificate information storage module is configured to store a DCC file, the signature, the timestamp, process data, and management data.

The process data refers to data related to the DCC generation and verification processes. For example, the process data may include initial certificate records, calibrator signature records, reviewer signature records, approver signature records, institutional signature records, and verification records.

The management data relates to data for managing the DCC. For example, the management data may include the calibration institution, calibration group, responsible personnel, and the certificate audit log.

In some embodiments, the certificate information storage module may acquire and store the DCC file, signature, timestamp, process data, and management data through the service subsystem, the processing subsystem, and the digital security subsystem.

The key information storage module is configured to store the digital signature and a corresponding key.

The key encrypts and decrypts digital signatures, for example, the key may include RSA and Chinese national standard SM2 keys.

In some embodiments, the key information storage module may acquire and store the digital signature and corresponding key through the digital security subsystem.

The data information storage module is configured to store the business data, background service data, and process control data.

The business data relates to specific processing tasks. For example, the business data may include time-frequency calibration business data and length calibration business data, etc.

The background service data refers to data generated during backend processing and transmission. For example, the background service data may include DCC data, calibration institution data, calibration group data, audit log data, and calibration personnel.

The process control data refers to processing workflow control data. For example, the process control data may include approval process data, calibrator signature records, reviewer signature records, approver signature records, and institutional signature records.

In some embodiments, the data information storage module may acquire and store the business data, background service data, and process control data through the service subsystem and the processing subsystem.

In some embodiments of the present disclosure, the DCC generation and verification system based on microservices architecture utilizes the user subsystem, the service subsystem, the processing subsystem, the digital security subsystem, and the storage subsystem to generate and verify the DCC, and obtain the DCC generation and verification result. (1) The present disclosure achieves high reliability, high stability, and easy iteration for the system through the microservices architecture. (2) The present disclosure standardizes, regulates, and streamlines information of calibrators, reviewers, and approvers using the DCC template and verification process. (3) The present disclosure ensures that the generated DCC meets IT requirements through the format verification process. (4) The present disclosure provides digital certificates to the calibration institutions, calibrators, reviewers, and approvers, utilizes the digital certificates to digitally sign the DCC, and applies trusted timestamps to the DCC content. Thus, the present disclosure ensures data integrity without tampering, and guarantees credible provider identity and data authenticity of the DCC. (5) The present disclosure incorporates the certificate management unit, ensuring that the compliantly produced DCC possesses a unique DOI for findability and accessibility of the DCC. The present disclosure verifies machine-readable and operable syntax compliance of the DCC to achieve operability and reusability, satisfying FAIR principles.

### Embodiment 2

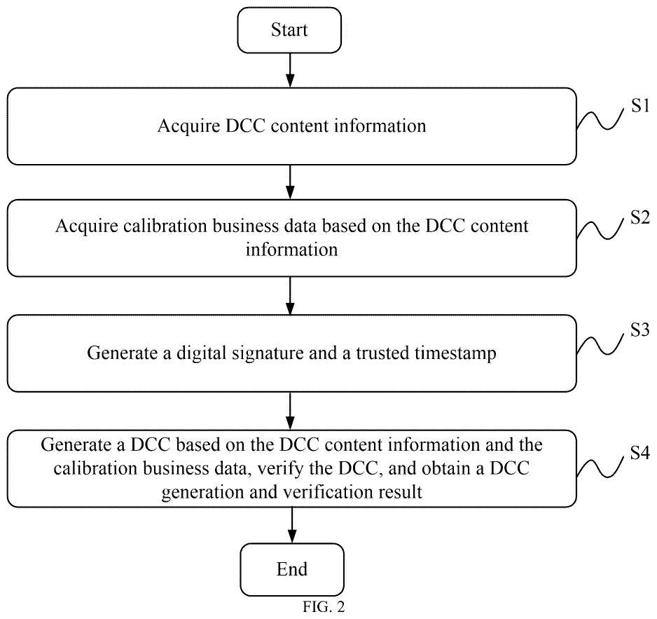

FIG. 2 shows an exemplary flowchart of a DCC generation and verification method based on microservices architecture according to some embodiments of the present disclosure. As shown in FIG. 2, a process of the method may include the following steps. In some embodiments, the process may be executed by a processor.
S1. DCC content information is acquired. More details regarding the DCC content information may refer to FIG. 1 and its related descriptions.
S2. Calibration business data is acquired based on the DCC content information. More details regarding the calibration business data may refer to FIG. 1 and its related descriptions.
S3. A digital signature and a trusted timestamp are generated. More details regarding the digital signature and the trusted timestamp may refer to FIG. 1 and its related descriptions.
S4. A DCC is generated based on the DCC content information, the calibration business data, the digital signature, and the trusted timestamp, and the DCC is verified, and a DCC generation and verification result is obtained. More details regarding the DCC generation and verification result may refer to FIG. 1 and its related descriptions.

What is claimed is:

1. A digital calibration certificate (DCC) generation and verification system based on a microservices architecture, comprising:
a user subsystem, configured to acquire DCC content information and transmit a DCC generation and verification result to a user;
a service subsystem, configured to provide an access service and acquire calibration business data based on the DCC content information;
a processing subsystem, configured to generate a DCC based on the DCC content information, the calibration business data, a digital signature, and a trusted timestamp, verify the DCC, and obtain the DCC generation and verification result;
a digital security subsystem, configured to authenticate the user subsystem through the service subsystem and provide the digital signature and the trusted timestamp to the processing subsystem; and
a storage subsystem, configured to store information and data during processing and provide corresponding information and the data to the processing subsystem.

2. The DCC generation and verification system based on the microservices architecture according to claim 1, wherein the user subsystem comprises:
a terminal module, configured to acquire the DCC content information through a terminal device; and
a server module, configured to transmit the DCC content information to the service subsystem.

3. The DCC generation and verification system based on the microservices architecture according to claim 1, wherein the service subsystem comprises:
a network service module, configured to provide the user with the access service to the generation and verification system; and
a digital calibration service module, configured to acquire the calibration business data based on the DCC content information through a time-frequency calibration business service and a length calibration business service.

4. The DCC generation and verification system based on the microservices architecture according to claim 1, wherein the processing subsystem comprises:
an interface module, configured to establish a security mechanism and connect the service subsystem to a business module and a core management module;
the business module, configured to generate the DCC based on the DCC content information, the calibration business data, the digital signature, and the trusted timestamp;
the core management module, configured to verify the DCC, and obtain the DCC generation and verification result; and
a configuration module, configured to configure and manage the business module and the core module.

5. The DCC generation and verification system based on the microservices architecture according to claim 4, wherein the business module comprises:
a module management unit, configured to acquire a corresponding DCC template based on a metrological standard in a specialized field;
a generation unit, configured to generate the DCC based on the DCC template, the DCC content information, and the calibration business data;
a security management unit, configured to apply the digital signature and a timestamp endorsement to the DCC, and obtain a security-managed DCC; and
a verification unit, configured to perform a format, syntax, and security verification on the security-managed DCC, to obtain a final DCC.

6. The DCC generation and verification system based on the microservices architecture according to claim 4, wherein the core management module comprises:
a certificate management unit, configured to perform a version update, a query, and a publication of the DCC and a corresponding digital unit system based on the DCC;
a permission management unit, configured to provide registration, permission assignment, and authentication management services for the user in the system;
a verification and calculation unit, configured to provide a corresponding calibration calculation function and verify the DCC through a verification and calculation tool based on a metrological standard, a professional terminology, and a verification code, and obtain the DCC generation and verification result;
an identifier management unit, configured to generate a persistent identifier (PID) and a digital object identifier (DOI) based on a verified DCC, thereby implementing a registration of the DCC; and
a vocabulary management unit, configured to provide the metrological standard, the professional terminology, and the verification code, thereby implementing a DCC generation and verification process.

7. The DCC generation and verification system based on the microservices architecture according to claim 4, wherein the configuration module comprises:
a configuration unit, configured to provide an information configuration service for the business module and the core management module;
a log management unit, configured to manage logs generated in the business module and the core management module;
a registration-discovery unit, configured to provide a registration-discovery component for the business module and the core management module and perform dynamic scheduling of the module based on a current application scale; and
a microservices unit, configured to visualize the business module and the core management module and manage the generated DCC.

8. The DCC generation and verification system based on the microservices architecture according to claim 2, wherein the digital security subsystem comprises:
a digital identity module, configured to provide digital identity information for the terminal module and the server module;
a digital signature module, configured to generate the digital signature through a cryptographic device; and
a trusted timestamp module, configured to generate the trusted timestamp through a timestamp server.

9. The DCC generation and verification system based on the microservices architecture according to claim 1, wherein the storage subsystem comprises:
a user information storage module, configured to store user information, authentication information, and management information;
a certificate information storage module, configured to store a DCC file, the signature, the timestamp, process data, and management data;
a key information storage module, configured to store the digital signature and a corresponding key; and
a data information storage module, configured to store the business data, background service data, and process control data.

10. A DCC generation and verification method based on a microservices architecture, configured to implement the DCC generation and verification system based on the microservices architecture according to claim 1, and comprising:
acquiring the DCC content information;
acquiring the calibration business data based on the DCC content information;
generating the digital signature and the trusted timestamp; and
generating the DCC based on the DCC content information, the calibration business data, the digital signature and the trusted timestamp, verifying the DCC, and obtaining the DCC generation and verification result.

11. The DCC generation and verification method based on the microservices architecture according to claim 10, wherein in the DCC generation and verification system based on the microservices architecture, the user subsystem comprises:
a terminal module, configured to acquire the DCC content information through a terminal device; and
a server module, configured to transmit the DCC content information to the service subsystem.

12. The DCC generation and verification method based on the microservices architecture according to claim 10, wherein in the DCC generation and verification system based on the microservices architecture, the service subsystem comprises:
a network service module, configured to provide the user with the access service to the generation and verification system; and
a digital calibration service module, configured to acquire the calibration business data based on the DCC content information through a time-frequency calibration business service and a length calibration business service.

13. The DCC generation and verification method based on the microservices architecture according to claim 10, wherein in the DCC generation and verification system based on the microservices architecture, the processing subsystem comprises:
an interface module, configured to establish a security mechanism and connect the service subsystem to a business module and a core management module;
the business module, configured to generate the DCC based on the DCC content information, the calibration business data, the digital signature, and the trusted timestamp;
the core management module, configured to verify the DCC, and obtain the DCC generation and verification result; and
a configuration module, configured to configure and manage the business module and the core module.

14. The DCC generation and verification method based on the microservices architecture according to claim 13, wherein in the DCC generation and verification system based on the microservices architecture, the business module comprises:
a module management unit, configured to acquire a corresponding DCC template based on a metrological standard in a specialized field;
a generation unit, configured to generate the DCC based on the DCC template, the DCC content information, and the calibration business data;
a security management unit, configured to apply the digital signature and a timestamp endorsement to the DCC, and obtain a security-managed DCC; and
a verification unit, configured to perform a format, syntax, and security verification on the security-managed DCC, to obtain a final DCC.

15. The DCC generation and verification method based on the microservices architecture according to claim 13, wherein in the DCC generation and verification system based on the microservices architecture, the core management module comprises:
a certificate management unit, configured to perform a version update, a query, and a publication of the DCC and a corresponding digital unit system based on the DCC;
a permission management unit, configured to provide registration, permission assignment, and authentication management services for the user in the system;
a verification and calculation unit, configured to provide a corresponding calibration calculation function and verify the DCC through a verification and calculation tool based on a metrological standard, a professional terminology, and a verification code, and obtain the DCC generation and verification result;
an identifier management unit, configured to generate a persistent identifier (PID) and a digital object identifier (DOI) based on a verified DCC, thereby implementing a registration of the DCC; and
a vocabulary management unit, configured to provide the metrological standard, the professional terminology, and the verification code, thereby implementing a DCC generation and verification process.

16. The DCC generation and verification method based on the microservices architecture according to claim 13, wherein in the DCC generation and verification system based on the microservices architecture, the configuration module comprises:
a configuration unit, configured to provide an information configuration service for the business module and the core management module;
a log management unit, configured to manage logs generated in the business module and the core management module;
a registration-discovery unit, configured to provide a registration-discovery component for the business module and the core management module and perform dynamic scheduling of the module based on a current application scale; and
a microservices unit, configured to visualize the business module and the core management module and manage the generated DCC.

17. The DCC generation and verification method based on the microservices architecture according to claim 11, wherein in the DCC generation and verification system based on the microservices architecture, the digital security subsystem comprises:
a digital identity module, configured to provide digital identity information for the terminal module and the server module;
a digital signature module, configured to generate the digital signature through a cryptographic device; and
a trusted timestamp module, configured to generate the trusted timestamp through a timestamp server.

18. The DCC generation and verification method based on the microservices architecture according to claim 10, wherein in the DCC generation and verification system based on the microservices architecture, the storage subsystem comprises:
a user information storage module, configured to store user information, authentication information, and management information;
a certificate information storage module, configured to store a DCC file, the signature, the timestamp, process data, and management data;
a key information storage module, configured to store the digital signature and a corresponding key; and
a data information storage module, configured to store the business data, background service data, and process control data.
